(19) United States
(12) Patent Application Publication
(10) Pub. No.: US 2006/0261094 A1
(43) Pub. Date: Nov. 23, 2006

(54) Dispensing apparatus

(76) Inventor: Tristian Roger Thornhill, Cambridgeshire (GB)

Correspondence Address: SMITH, GAMBRELL & RUSSELL, 1850 M STREET, N.W., SUITE 800, WASHINGTON, DC, 20036, US

(21) Appl. No.: 10/554,084

(22) PCT Filed: Feb. 27, 2004
(86) PCT No.: PCT/GB04/00789

§ 371 Date: Oct. 21, 2005

(30) Foreign Application Priority Data
Apr. 22, 2003 (GB) 0309123.8

(51) Int. Cl. G01F 11/00; A62C 13/62; B05B 7/26; F23D 14/28

(52) U.S. Cl. 222/216; 239/302; 239/337; 239/315

(57) ABSTRACT

The present invention relates to a dispensing apparatus (1) comprising a housing (3) and a metering tube (7). The metering tube (7) has an opening (17) to the interior thereof and the housing (3) has a chamber (4) therein for storing medicament. The metering tube (7) is extendable to a dispensing position, and retractable to a filling position. The opening (17) is in communication with the chamber (4) when the metering tube is in the filling position. The invention further relates to a method of operating dispensing apparatus.

The invention relates to apparatus for dispensing liquids. More particularly, the invention relates to apparatus for dispensing metered doses of medicaments.

It is known from the Applicant's earlier International application PCT/GB93/02194 to provide dispensing apparatus to deliver a metered dose of liquid from a reservoir. The apparatus described in this application relies, in one embodiments on one-way valves used in combination with a piston to deliver metered volumes of fluid. However, if an adequate seal is not created by the valve between the piston and the reservoir, fluid may be forced back into the reservoir when the piston is actuated. Thus, the metered dose dispensed may not be accurate.

There remains a need to provide apparatus for accurately dispensing metered doses of medicament. The present invention in preferred embodiments attempts to address this need.

Viewed from a first aspect the present invention provides a dispensing apparatus comprising a housing and a metering tube, said metering tube having an opening to the interior thereof, and said housing having a chamber therein for storing medicament;

said metering tube being extendable to a dispensing position, and retractable to a filling position;

wherein said opening is in communication with said chamber when said metering tube is in said filling position.

The retraction of the metering tube into the chamber facilitates the measurement of a metered dose of medicament to a high degree of accuracy. The extension of the metering tube to the dispensing position facilitating accurate dispensing of the metered dose.

After dispensing the medicament, the metering tube may be retracted. Advantageously the surface tension in the dispensed medicament may draw any medicament from the tip of the metering tube so that only a small residue remains. Thus, retracting the metering tube after dispensing the medicament may still further improve the accuracy of the dispensing apparatus. The retraction of the metering tube into the housing also reduces the possibility of it being damaged, or contamination occurring, when the dispensing apparatus is not in use.

The dispensing apparatus preferably comprises a piston for drawing medicament from the chamber into the metering tube when the tube is in the filling position and preferably also to expel medicament from the dispensing apparatus when the tube is in the dispensing position. The medicament is preferably drawn into the indexing tube and expelled through the same opening.

The piston may be mounted remotely from the indexing tube and connected, for example, by a flexible tube to accommodate the movement of the indexing tube. Preferably, however, the piston is moveable with the metering tube to simplify construction. Most preferably, the piston is provided inside said metering tube.

Although the length of the piston stroke may be varied to allow different volumes of medicament to be drawn into the metering tube, the stroke length is preferably fixed so that a predetermined volume of medicament is drawn into the tube from the chamber each time the apparatus is used.

In arrangements where the piston is moveable with the indexing tube, at least one member is preferably provided on the metering tube to limit the displacement of the piston in at least one direction.

The displacement of the indexing tube relative to the housing is preferably limited, for example by at least one stop provided on the housing and/or the indexing tube, to reduce the likelihood of the indexing tube being damaged in use. The at least one stop is preferably a collar provided on the indexing tube.

The dispensing apparatus as described herein may be used as part of a hand-held inhaler for oral delivery of medicament. When used in inhalers the apparatus preferably further comprises apparatus for delivering the dispensed medicament as an atomised mist.

Viewed from a further aspect the present invention provides a method of operating dispensing apparatus comprising a housing and a metering tube, the housing having a chamber and medicament being provided in said chamber, wherein the method comprises the steps of:
(a) retracting said metering tube to a filling position;
(b) drawing medicament into said metering tube from said chamber;
(c) extending said metering tube to a dispensing position; and
(d) expelling medicament from said metering tube.

The apparatus preferably further comprises a piston. The movement of the piston in a first direction preferably draws medicament into the metering tube in accordance with step (b) of the method, and movement of the piston in a second direction preferably expels medicament from the metering tube in accordance with step (d) of the method.

The piston and the metering tube are preferably moveable together during steps (a) and (c) of the method.

The dispensing apparatus may be provided in a hand-held inhaler for oral delivery of medicament. When used in an inhaler, the medicament is preferably dispensed from the metering tube to an atomising apparatus and the method further comprises the step(s) of atomising the medicament and delivering it as an atomised mist.

Preferably the metering tube is retracted before the medicament is atomised as the surface tension in the dispensed liquid draws substantially all of the liquid off the tip of the indexing tube, leaving only a small residue.

A preferred embodiment of the present invention will now be described, by way of example only, with reference to the accompanying drawings in which:

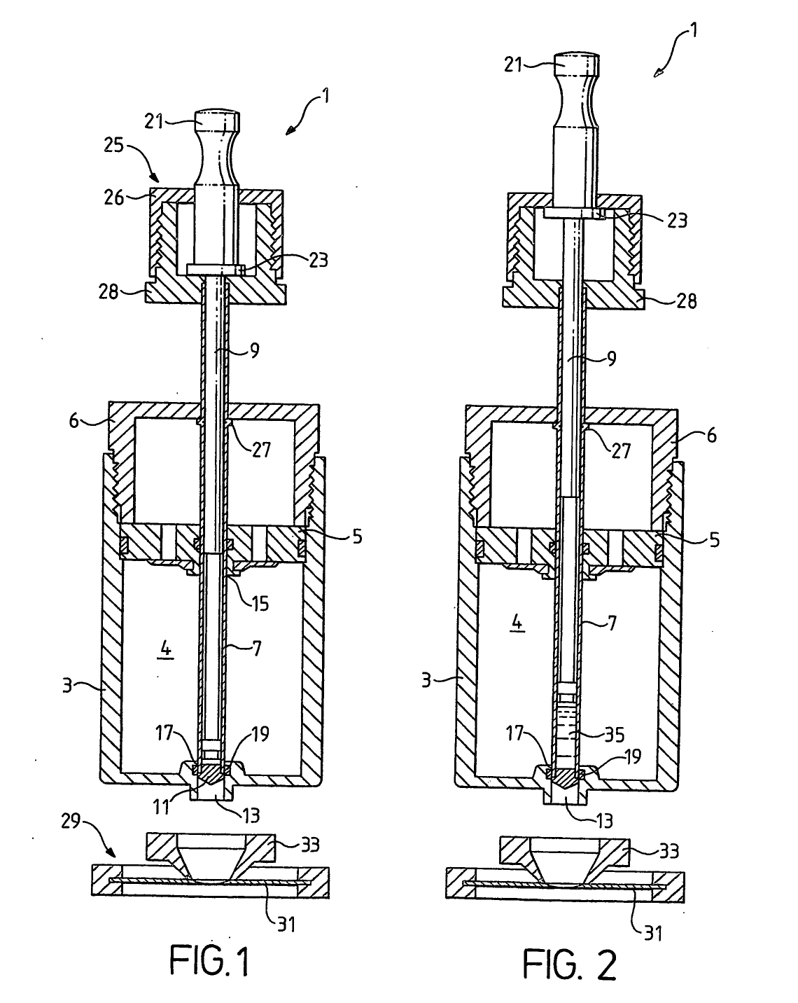

FIG. 1 shows the dispenser in a storage position;

FIG. 2 shows the dispenser in a charged position;

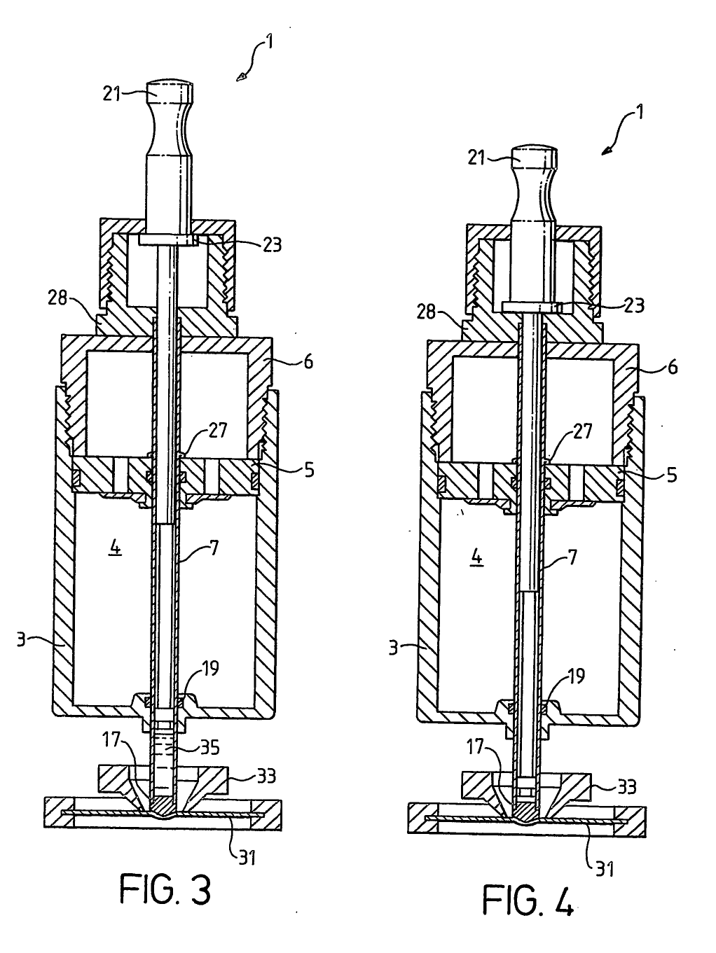

FIG. 3 shows the dispenser in an extended position;

FIG. 4 shows the dispenser in a discharged position;

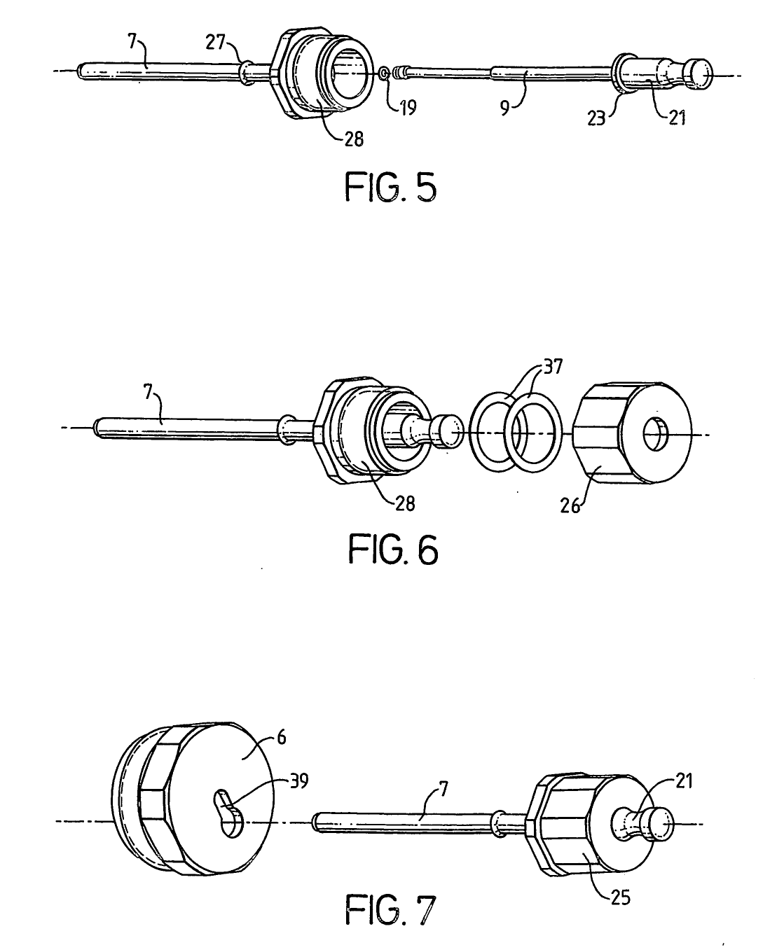

FIG. 5 shows an exploded view of the piston and indexing tube assembly;

FIG. 6 shows an exploded view of the indexing tube end cap assembly;

FIG. 7 shows an exploded view of the indexing tube and retaining cap assembly;

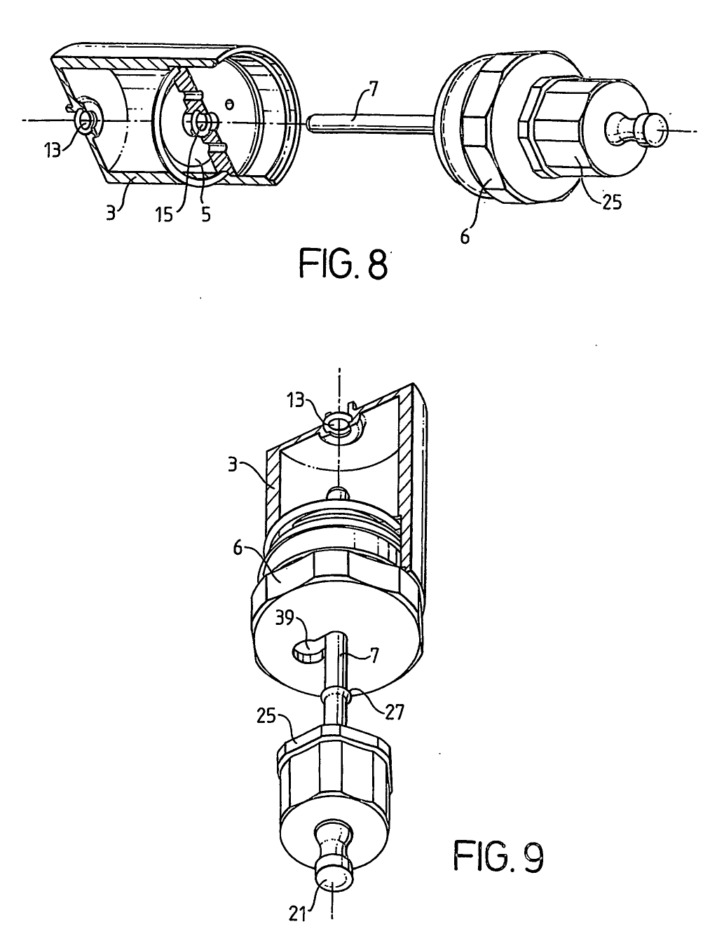

FIG. 8 shows a partial cross-section of the housing assembly; and

FIG. 9 shows a partial cross-section of the dispenser ready for filling.

A dispenser 1 in accordance with the present invention is shown in FIG. 1. The dispenser 1 has a housing 3 having a chamber 4 defined therein by a sealing member 5. An O-ring is provided around the sealing member to seal the chamber. A medicament (not shown) to be dispensed is stored in the chamber. A retaining cap 6 is provided on the upper end of the housing to retain the sealing member in position.

A metering tube 7 is slidably mounted in the housing 3. An end piece 11 is provided in the metering tube 7 to seal the distal end thereof. An opening 17 is provided in the side wall of the distal end of the metering tube 7 to provide access to the interior thereof. The metering tube extends through a first opening 13 in the housing and a second opening 15 in the sealing member 5. O-rings are provided at each of the first and second openings to seal the chamber 4.

A piston 9 is slidably located in the metering tube 7 and an O-ring 19 is provided at the distal end thereof to create a seal. A handle 21 is provided at the proximal end of the piston to enable a user to displace the piston relative to the metering tube.

An end cap 25 comprising upper and lower members 26, 28 is mounted on the proximal end of the metering tube. A cavity is defined in the end cap between the upper and lower members 26, 28 to receive the handle 21 of the piston 9.

A projection 23 provided at the base of the handle 21 in use limits the length of the piston stroke by abutting the upper and lower end cap members 26, 28 when the piston is displaced. Similarly, a collar 27 integrally formed in the sidewall of the indexing tube 7 abuts the retaining cap 6 and the sealing member 5 to limit the displacement of the tube relative to the housing 3.

The dispenser 1 is typically used in a hand held inhaler for oral inhalation of medicament. To deliver the medicament in an atomised mist for inhalation, the dispenser 1 dispenses the medicament onto an atomising apparatus 29. An atomisation apparatus suitable for use with the present invention is disclosed in the Applicant's earlier UK Patent No. 2240494.

The atomising apparatus 29 comprises a perforated member 31 which is vibrated by an electro-acoustic transducer (not shown) to produce the atomised mist. A trough 33 is provided above the perforated member 31 to receive the medicament dispensed from the dispenser 1.

The operation of the dispenser 1 in accordance with the present invention will now be described with reference to FIGS. 1 to 4. The dispenser 1 is stored with the metering tube 7 retracted into the housing ready for filling of the metering tube. In this position the opening 17 is in fluid communication with the medicament in the chamber 4 and this advantageously ensures that the opening and the interior of the metering tube do not dry out.

When the dispenser 1 is in the storage position, the piston 9 is preferably displaced downwardly to minimise the volume of medicament stored inside the metering tube 7 to facilitate thorough mixing of the medicament prior to dispensing.

Prior to charging the metering tube, the dispenser 1 is shaken to disperse any particulates in the medicament in the case that the medicament is stored in the form of a suspension. Medicament in the form of a solution does not require agitation prior to charging. With the dispenser in the upright position, as shown in FIG. 1, the plunger 9 is moved upwardly, relative to the metering tube 7. The displacement of the piston relative to the metering tube effectively creates a metering chamber into which a metered dose 35 of medicament is drawn via the opening 17.

The upward displacement of the piston 9 is limited by the projection 23 which abuts the upper portion 26 of the end cap 25. The length of the piston stroke determines the volume of medicament drawn into the metering tube; thus, the metered dose 35 may be varied by changing the piston stroke. The piston stroke may be changed, for example, by inserting spacer rings or shims 37 between the upper and lower portions 26, 28 of the end cap 25, as shown in FIG. 6. Preferably the length of the piston stroke, and thus the volume of the metered dose, is fixed when the dispenser 1 is manufactured.

The next stage in the operation of the dispenser 1 is to displace the metering tube 7 and the piston 9 downwardly together, i.e. with substantially no relative movement therebetween. This action extends the distal end of the metering tube 7 out of the housing 3 to the dispensing position. In the dispensing position the opening 17 is also displaced out of the housing.

Medicament is dispensed from the dispenser 1 by displacing the plunger 9 downwardly to expel the metered dose 35 from the interior of the indexing tube 7 through the opening 17. The indexed dose is collected in the trough 33 of the atomising apparatus 29 ready for delivery as an atomised mist. At the end of the piston stroke, the tip of the piston 9 is preferably immersed in the dispensed metered dose.

Prior to operation of the atomising apparatus 29, the metering tube 7 is preferably withdrawn and returned to the original storage/filling position. As the metering tube is withdrawn, the surface tension in the dispensed metered dose 35 draws any fluid remaining on the tip of the end member 11 into the trough 33. Thus, only a small residue of medicament may remain on the tip of the metering tube. The atomising apparatus 29 may then be operated in accordance with known practise.

The construction of the dispenser 1 will now be described with reference to FIGS. 5, 6 and 7. The O-ring 19 is located on the distal end of the piston 9 prior to insertion of the piston into the indexing tube 7, as shown in FIG. 5. The upper portion 26 of the end cap 25 is then screwed onto the lower portion 28 such that a portion of the handle 21, including the projection 23, is located in the cavity defined in the end cap. As shown in FIG. 6, one or more shims 37 may be inserted between the upper and lower portions of the end cap member to vary the stroke of the piston 9, if required.

The indexing tube 7 and piston 9 are then inserted through the retaining cap 6. As shown in FIG. 7, a key-hole slot 39 is provided in the retaining cap to facilitate introduction of the collar 27. In use, the collar abuts the retaining cap around the narrower central slot portion of the key-hole slot to limit the displacement of the indexing tube.

The indexing tube 7 is then inserted through the opening 15 in the sealing member 5 and the opening 13 in the distal end of the housing 3, as shown in FIG. 8. The retaining cap 6 is then screwed into position on the housing 3 to secure the assembly.

The method of filling the chamber 4 with medicament or other fluid will now be described with reference to FIG. 9. The dispenser 1 is inverted so that the opening 13 in the distal end of the housing 3 is at the top. The retaining cap 6 is then unscrewed and the collar 27 moved to the other side of the retaining cap. The retaining cap is then screwed back into the housing 3 with the metering tube 7 retained in position in the sealing member 5, but retracted sufficiently to leave the opening 13 in the distal end of the housing 3 unobstructed.

A syringe with a needle of approximately 1 mm diameter is then inserted through the opening 13 into the housing 3 and the required amount of fluid injected through the opening into the chamber 4.

The volume injected into the chamber 4 should leave at least 15% of the internal volume of the chamber unfilled in order to facilitate agitation of the fluid by shaking to disperse solid particles. The charge volume of the chamber 4 may be, for example, 5.1 ml.

After the liquid has been injected into the chamber 4, the retaining cap 6 is again unscrewed and the collar 27 of the metering tube 7 moved through the key hole-slot 37 to the inside of the retaining cap. The retaining cap is then screwed back into position.

Although the dispenser 1 in accordance with the present invention has been described for use in conjunction with atomising apparatus 29, the skilled person will appreciate that the dispenser may equally be used for other applications where the accurate dispensing of a metered dose of medicament is required. Indeed, the skilled person will appreciate that the dispenser may be used in any application required dispensing of a fluid and is not limited to dispensing of medicaments.

1. A dispensing apparatus comprising a housing and a metering tube, said metering tube having an opening to the interior thereof and said housing having a chamber therein for storing medicament;
said metering tube being extendable to a dispensing position, and retractable to a filling position;
wherein said opening is in communication with said chamber when said metering tube is in said filling position.

2. Dispensing apparatus as claimed in claim 1 further comprising a piston for drawing medicament into said metering tube and expelling medicament from said metering tube.

3. Dispensing apparatus as claimed in claim 2 wherein the length of the piston stroke is fixed.

4. Dispensing apparatus as claimed in claim 2 or 3 wherein at least one member is provided on said metering tube to limit the displacement of the piston in at least one direction.

5. Dispensing apparatus as claimed in any one of claims 2 to 4 wherein the piston is provided inside said metering tube.

6. Dispensing apparatus as claimed in any one of claims 2 to 5 wherein said piston is moveable with said metering tube.

7. Dispensing apparatus as claimed in any preceding claim wherein at least one stop is provided to limit the displacement of the metering tube.

8. Dispensing apparatus as claimed in any one of the preceding claims wherein the dispensing apparatus is provided in a hand-held inhaler for oral delivery of medicament.

9. Dispensing apparatus as claimed in any one of the preceding claims further comprising apparatus for delivering the dispensed medicament as an atomised mist.

10. A method of operating dispensing apparatus comprising a housing and a metering tube, the housing having a chamber and medicament being provided in said chamber, wherein the method comprises the steps of:
(a) retracting said metering tube to a filling position;
(b) drawing medicament into said metering tube from said chamber;
(c) extending said metering tube to a dispensing position; and
(d) expelling medicament from said metering tube.

11. A method as claimed in claim 10 wherein said apparatus further comprises a piston, wherein movement of the piston in a first direction draws medicament into the metering tube in accordance with step (b), and movement of the piston in a second direction expels medicament from the metering tube in accordance with step (d).

12. A method as claimed in claim 11 wherein the piston and the metering tube are moved together during steps (a) and (c).

13. A method as claimed in any one of claims 10 to 12 wherein the medicament is dispensed from the metering tube to an atomising apparatus and the method further comprises the step(s) of atomising the medicament and delivering it as an atomised mist.

14. A method as claimed in claim 13 wherein the metering tube is retracted before the medicament is atomised.

15. A method as claimed in any one of claims 11 to 14 wherein the dispensing apparatus is provided in a hand-held inhaler for oral delivery of medicament.

16. Dispensing apparatus substantially as described herein with reference to the attached Figures.

17. A method of using dispensing apparatus substantially as described herein with reference to the attached Figures.
